(19) United States
(12) Patent Application Publication
(10) Pub. No.: US 2014/0310207 A1
(43) Pub. Date: Oct. 16, 2014

(54) CHRONOLOGY-CENTRIC, CASE-ENTITY INFORMATION HANDLING SYSTEM AND METHODOLOGY

(71) Applicant: Lifecom, Inc., Portland, OR (US)

(72) Inventors: Stephen J. Datena, Portland, OR (US); Bart E. Lonchar, Portland, OR (US); Robert D. Beck, Portland, OR (US)

(73) Assignee: Lifecom, Inc., Portland, OR (US)

(21) Appl. No.: 14/249,167

(22) Filed: Apr. 9, 2014

Related U.S. Application Data
(60) Provisional application No. 61/810,693, filed on Apr. 10, 2013.

(51) Int. Cl. G06N 5/02

(52) U.S. Cl. CPC G06N 5/02
USPC 706/11

(57) ABSTRACT

A chronology-centric, defined-knowledge-domain information-handling methodology supported by a system featuring (a) a dynamic EDP data repository, (b) plural EDP case-entity chronologies stored in the repository in the forms of respective, internally time-stamped and chronologically-organized groups of EDPs that effectively define, case-entity-specific, respectively different stage-and-time EDP-condition identities of particular domain-associated subject matter, and (c) data-processing engine structure connected to the repository for recurrently and progressively interacting with the data repository in relation to at least one of constructing, re-constructing, accessing, and reporting the respective organizations, contents and significances of, selected case-entity chronologies, as well, if user requested at a particular point in time, as performing, and output reporting user-sought information associated with, relevant, selected, time-and-stage EDP-content registry alignments between different case-entity chronologies present in the repository.

### CROSS-REFERENCE TO RELATED APPLICATION

This application claims priority to U.S. Provisional Patent Application Ser. No. 61/810,693, filed Apr. 10, 2013, for “Time-Based, Medical Case-Entity, Master-Key Cloud-Form Mapping and Utilization”, the entire disclosure content in which provisional application is hereby incorporated herein by reference.

### BACKGROUND AND SUMMARY OF THE INVENTION

This invention pertains to computer-based, knowledge-domain information processing, practiced in and by a system which relationally springs, but differs, from that of a generally functionally related predecessor described in U.S. Pat. No. 7,389,280, the entire disclosure content in which is hereby incorporated herein by reference. Simply stated in a comparative sense, whereas the prior '280-patent system and methodology perform all data-handling activities, when called upon to act, in relation to an essentially fixed-in-time data structure, the present invention employs an incorporated, dynamic, historical-content, chronology-centric data structure which, at all times, presents internally, for system-implemented methodologic user requested review and assessment of relevant knowledge-domain subject matter, a time-stamped, time-staged data representation of selected knowledge-domain information.

We refer to such a data structure as a chronology-centric, case-entity data structure.

The invention contemplates ongoing data-structure revisions, all appropriately time-stamped/time-staged to keep the dynamic, case-entity data structure historically alive.

The knowledge-relevant exploratory power of this unique, case-entity data structure, brings the substance of progressive, subject-matter-condition history into the foreground of subject-matter condition and status understanding and management assessment. It also sets a significant stage for successful predictive management of, and high-potential anticipatory control over, yet-to-come, subject-matter prognosis.

The invention is usable with any knowledge domain of a type which contains subject-matter entities, conditions or situations that consist of, or display, a chronological evolution or progression, respecting which data relevant to a character-assessment, and/or a staging-status-appraisal, of such an entity, condition or situation varies over time, and can be modeled using the chronology-centric, “case-entity” centerpiece format of the present invention.

While other, special, terminology definitions will be presented later in this text, we begin at this point stressing the definition of the “case entity” concept and terminology. Essentially, as we employ that concept and terminology herein with descriptive and characterizing application to all embodiments and manners of practicing the present invention, a case entity takes the form, in a computer accessible, digital data registry, of a stored-data chronology consisting of time-stamped, stage-of-condition-relevant, and chronologically-organized groups, or blocks (also referred to as time blocks) of EDPs (known as elemental data points—described more fully below) which effectively define and represent electronically respectively different stage-and-time, EDP-condition identities of particular knowledge-domain-associated subject matter(s). Illustrations of such chronologies, which we call “case entities”, include, for examples, (a) the time-stamped progressively changing operational condition of a car as related to the knowledge domain of motor vehicles, (b) the time-stamped progression of a disease in a patient as associated with the knowledge domain of medicine, and (c) the characteristic, historical-content, staged progression of any medical condition, per se—also as associated with the knowledge domain of medicine.

The herein uniquely proposed and employed time-progression, case-entity data representation of real-world subjects furnishes a user with an extremely robust environment for understanding time-variant subjects within, and aspects of, a knowledge domain—an environment that allows a user to perceive how time-progression changes that are associated with a selected subject affect an understanding of what is “going on” with that subject in manners offering powerful insights into subject-condition and subject-behavioral matters. The case-entity chronologies that are employed in accordance with the system and practice of the present invention significantly differ from earlier kinds of tools furnished for assessment practices in different fields of knowledge, which earlier-provided tools, while very useful in certain applications, essentially do not relate currently made assessments to data that describe historical-content condition changes which characteristically happen over time—instead focusing attention on more-or-less than current, static conditions associated with a subject matter of interest.

While the present case-entity invention is applicable, and should be understood to be useful in relation, to a wide range of knowledge domains, it has been found to offer immediate and special utility in relation to the knowledge domain, or field, of medicine. Accordingly, a specific embodiment of, and manner of practicing, the invention, are illustrated and described herein in the setting of the knowledge domain of medicine. One should, accordingly, recognize that the medicine-field-specific teachings provided in greater detail herein are meant to be readable, in applicability, on other knowledge domains, effectively simply by substituting for the herein-included medical-field language, the appropriate parallel-relationship language drawn from such other domains.

Proceeding at this point in a focused manner utilizing this just-described, parallel-relationship mode of disclosure, we will now, representationally, discuss, immediately below in the present invention-background-discussion setting, the invention with regard to its pertinence to the field of medicine, and in particular, as related to this field, to an information/knowledge system and methodology which build upon the invention disclosed in the '280 patent, especially with reference to the presence, nature, and content, according to the present invention, of time-relevant, chronology-centric EDP case-entities that form pivotally significant functionality features in a dynamic EDP data structure upon which the advanced performance capabilities of the present system and methodology depend.

The '280 patent discloses a system and a methodology employing a special, adaptive, digital knowledge engine (referred as an AKE), and an associated library of stored, subject-area-domain EDP information, designed to perform focused domain-relevant assessments and diagnoses of various problems and situations in any one of a very wide field of subject areas (knowledge domains). In particular, it discloses such a system and methodology which strongly mimic the natural human thought process, and which are structured with powerful interactive and adaptive capabilities to grow and “learn” in the particular subject area to which its “attention” is directed. More about this earlier, patented contribution to the relevant art is readable in the text, and from the drawings, present in the '280 patent, and one is, therefore, here guided, in the context of reading the present written invention description, to that patent-content text and drawings for an elaborated understanding of the '280-patent teachings in relation to their contributions to, and as a part of, the herein furnished description of the nature of the present invention.

Apart from the unique and strongly differentiating chronology-centric, case-entity time-progression-focused data-structure features of the present invention, and the specific systemic and methodologic approaches employed to process, and to present output material regarding, employment of information in such a case-entity-environment, most of the central data-handling and processing tasks implemented by, and in relation to, functioning of the '280 system and methodology occur here. For this reason, descriptions of those common-characteristic tasks are only tangentially and lightly presented herein, and one should, accordingly, consult the full text and drawing content of the '280 patent for greater elaboration. For example, exactly how a user engages the system of the present invention with respect to data input and the presentations of all relevant queries is essentially fully modeled in the '280 patent, and not discussed in any detail herein.

As a representative, but non-limiting, practical-implementation illustration of the invention disclosed in the '280 patent, the patent, with particularity, describes the there-associated invention, as mentioned above, in the context of the field of medicine, the very field, as is also stated above, in which the present invention, in one of its specifically implemental forms (now being discussed with a focus) “sits”. In this medical-field setting, the illustrative description provided in this patent more tightly focuses specific attention on just one character, or type (among many possible characters, or types) of what we herein refer to as a “medical condition”, and namely the medical condition known as medical diagnosis. Other important types of medical conditions, for the purpose of at least partially defining that term as employed herein, include diseases, procedures and therapeutic protocols. In the representational realm of the knowledge domain of medicine, we describe the present invention herein, without any intended limitation, in the illustrative context of the “diseases” type of medical conditions.

The adaptive knowledge engine described and discussed in the '280 patent employs what is referred to there as a data-component/EDP database which is engaged by the engine in a sophisticated practice, handling and utilizing what are called EDP assessments, and EDP-associated and containing Master Keys, Results Keys, and diagnostic-assessment Results, or Results Sets, drawn effectively from this database to generate and develop, from certain, very basic, and very fundamental-level, user (person or machine)-entered, system-input information, extremely useful and accurate diagnostic-assessment output results. This prior-art patent-described practice, and the patent-described, important, associated EDP assessments, EDP-containing Master Keys, Result Keys, diagnostic-assessment Results and Results Sets, have a kind of fixed-in-time, static, subject-descriptive/identifying nature at the moment when the associated system is engaged by a user. The '280-patent-described relationship between a Master Key and a Result, under all circumstances, is that a given Result is associated with just one, and one only, Master Key. This “one, and one only” relationship significantly differs in comparison with that which is involved in and with respect to the present invention, wherein a given Result is associated with a chronologically organized, time-progressive and thus time-differentiated, collection of plural Master Keys known as a case entity, as above-mentioned.

Further explaining, and as will become apparent, in relation to the present invention, Master Keys, Result Keys, diagnostic-assessment Results and Results Sets are also involved, but Master Keys, and their contents, are not statically represented. Rather, Master Keys are organized in historical-content chronologies to form Master-Key-associated case entities in which all Master Keys in a given such case entity relate to a single, specific Result.

Apart from Master-Key-associated case entities in relation to the present invention, there are, and may selectively be, many other forms/examples of case entities, such as (a) a patient-specific, assessment-based, disease-relevant case entity, (b) a patient-global, assessment-based, disease-relevant case entity assembled from a large (global) population of patients, (c) a car operational-status, assessment-based, case entity, (d) a biological plant-development, assessment-based, case entity, and countless others as freely specified by system and methodology users.

Included as centrally important contents of assessments, Master Keys, Result Keys, diagnostic-assessment Results and Results Sets are EDPs which form the critical, functional building blocks of the method and apparatus of the present invention, and of the invention described in the '280 patent. These building blocks take the form of elemental and fundamental, inferential components which are referred to herein as the above mentioned, elemental data points (EDPs). Two types of such EDPs are employed. One is referred to as a simple EDP, and the other as a complex EDP. A simple EDP consists of a singular data component, such as the word “shoulder” in a medically focused embodiment of the invention. A complex EDP consists of the associated combination of a single problem type, such as the word “pain” (in the medical field), and at least one data component, such as the word “shoulder” just mentioned.

The TABLE presented immediately below diagrams the relationships of EDPs, problem types, and data components:

TABLE

| | Problem Type | Data Component |
|---|---|---|
| Simple EDP | n/a | Patient Age Band: 30-49 |
| Complex EDP | Pain | Location: Shoulder |
| | | Onset: Sudden |
| | | Frequency: Constant |

These EDPs are lowest-common-denominator-type elements that relate to, and represent, a wide spectrum of identities, natures, characteristics, etc., (ultimately all that can be identified) which are relevant to the possibilities, variations and permutations of matters involving particular, selected subject areas, or domains. Put another way, each EDP permits no further relevant subdivision that will, during an assessment and information-handling practice/process, for example, enhance the capability for further problem and/or situation assessment differentiation. EDPs, as mentioned, populate assessments, Result Keys, and Result Keys populate Master Keys.

In the practice of the invention described in the '280 patent, as well as in the practice of the present invention, an “assessment” is what results from operation of the disclosed system in relation to user (person or machine)-entered inquiry data. It takes the form of a collection of EDPs determined by the system effectively to describe, or define, at the particular moment in time of the inquiry, some particular subject matter associated with the relevant knowledge domain. Assessments made in succession over time regarding such a particular subject matter form time-stamped, assessment-based case entities in the practice of the present invention.

A Result Key is a collection or pattern, typically, of EDPs that represent a unique presentation of an assessment result that is known and documented, and which is assigned a particular degree of certainty. A Result Key is thus a combination of EDPs that represent electronically and define a reportable result with some reliable degree of certainty. Result Keys are effectively “organized” into the contents of identifiable Master Keys, where each Master Key is effectively a collection of all EDP's that are associated with a single result, and Result Keys are identifiable collections of these EDPs which point, with different degrees of certainty, to that same result.

In the system and methodology illustrated and described in the '280 patent, the data-processing arrival from an initial data entry at an assessment/diagnosis output result is based upon the employment, among other things, of what may be referred to, as mentioned above, as a static Master Key—an assembly of EDP data which is characterized by an “at-that-time-existing” collection of result-defining EDPs—in other words, a Master-Key employment residing in the realm of Master Keys which have, at the moment in time that an assessment activity is performed, a fixed and very specific, non-chronological EDP-content characteristic.

In accordance with the present invention, as is stated above, and as will be described herein, and illustrated, in greater, shortly-following detail, the concept and realization of historical-content case-entity chronology, and such a chronology which is dynamically revisable over time, as proposed by the present invention, changes this prior-art “picture” in a dramatic way.

In relation to this statement, there are several high-level ways of expressing the present invention and its differentiating features.

(I) From a generalized structural vantage point, what is proposed by the present invention is a chronology-centric, defined-knowledge-domain information-handling system which accommodates the inputting, processing, and outputting, including visual outputting, of domain-relevant data and associated information under the external control of a system user seeking selected knowledge-domain matter-assessment and other information, such as related, subject-matter-linked, potential user-subject-matter-interaction guidance information.

This system includes (1) a dynamic EDP data repository, (2) plural EDP case-entity chronologies stored as EDP data in this repository in the forms of respective, internally time-stamped and chronologically-organized groups of EDPs that effectively define, in relation to a given case entity, respectively different stage-and-time EDP-condition identities of particular domain-associated subject matter, and (3) data-processing engine structure which is operatively connected to the repository, and operable, in accordance with user information-flow interactions with the system, and utilizing appropriately the data inputting, processing and outputting capabilities of the system, for recurrently and progressively interacting with the data repository in relation to at least one of constructing, re-constructing, accessing, and reporting the respective organizations, contents and significances of, selected case-entity chronologies, as well, if user requested at a particular point in time, as performing, and output reporting user-sought information associated with, relevant, selected, time-and-stage EDP-content registry alignments between different case-entity chronologies present in the repository.

Preferably, this system further includes visual display structure which is operatively connected to the included engine structure, and wherein output reporting of user-sought information associated with relevant, selected, time-and-stage EDP-content registry alignments between different case-entity chronologies present in the repository takes the form of time-based graphical imagery picturing of such alignments.

(II) From a medical-knowledge-domain, specific, representational, structural point of view, the invention may be characterized as a digital-computer-based, chronology-centric medical system for recurrently, and selectively, assessing a topically-chosen, patient-specific medical condition, and for thereby potentially enhancing, as appropriate, the management, over time, of any such condition, said system including:

(A) input/output interface structure, possessing visual display structure, (a) for time-noted inputting of patient-associated data relevant to performance by the system of a time-stamped, patient medical-condition assessment, and (b) for presenting, via the visual display structure, system-created EDP-based output information including (1) patient-associated, time-stamped, medical-condition assessment information, and (2) patient-medical-condition management-relevant guidance information;

(B) appropriately programmed, data-processing engine structure operatively connected to the interface structure, operable for processing and handling input and output information relating to (1) assessments, and (2) medical-condition management-guidance information, associated with a patient;

(C) a dynamic EDP data repository operatively connected to the interface structure and engine structures, containing plural, medical-condition-related EDPs organized, in different parts of the repository, and as appropriate for specific, different EDP-focus natures, into (1) plural, medical-condition-specific, historical-content, time-and-stage-of-condition-organized, Master-Key case-entity chronologies, and (2) medical-condition-associated, historical-content, (a) patient-population-global, and (b) individual patient-specific, assessment-based and internally time-organized, case-entity chronologies, wherein each case-entity chronology includes, as relevant to the subject-matter nature of EDPs in the chronology, groups of EDPs that effectively define, in relation to a given case entity, respectively different stage-and-time EDP-condition identities of the chronology-associated subject matter; and

(D) case-entity-chronology revision structure, operable, as an included part of the engine structure, for receiving case-entity-chronology revision information, and for acting upon such received information to revise, within selected case-entity chronologies, one or more selected, included EDP groups, in manners respecting, as appropriate, both (1) time-stage EDP-group organization within the chronology, and (2) EDP content within a selected, included EDP group.

(III) From a methodological point of view, and as expressed in the realm of a medical knowledge domain, the invention may be characterized as a chronology-centric medical-condition assessment, diagnosis, and medical-condition management-guidance methodology including:

(A) engaging, through an appropriate interface, and via EDP-associated dialogue relating to an inquiry respecting at least one of (1) presently assessed status, and (2) time-forward management-guidance, aspects of a patient's medical condition, a computer-based medical knowledge system which includes a data-processing engine, and an operatively connected, dynamically revisable data structure characterized by containing plural, medical-condition-related EDPs that represent, in digital electronic forms, physical aspects of human physiology and health, organized, in different parts of the repository, into (a) plural, medical-condition-specific, historical-content, time-and-stage-of-condition-organized, Master-Key case-entity chronologies, and (b) medical-condition-associated, historical-content, (i) patient-population-global, and (ii) individual patient-specific, assessment-based and internally time-organized, case-entity chronologies, wherein each case-entity chronology includes, as relevant to the subject-matter nature of EDPs in the chronology, groups of EDPs that effectively define, in relation to a given case entity, respectively different stage-and-time EDP-condition identities of the chronology-associated subject matter; and

(B) by such engaging, triggering to come as output from the system visually readable output information which identifiably characterizes the inquiry, in a time-based registry alignment manner, as possessing a present relationship of the patient's medical status to one or more medical-condition, historical-content chronologies.

This methodology may also be structured whereby the triggering of visually readable output information implements the creating, and presenting on a visual display structure which is associated with the mentioned interface, of time-based graphical imagery picturing time-and-stage-of-condition EDP-content registry alignments between different case-entity chronologies present in the repository.

These just-expressed, several, structural and methodological features and organizations of the present invention, as well as others, are directly illustrated in the drawings, to which we now direct attention along with the thereafter following, detailed description of the invention. In a manner of speaking, and as will become apparent, the principal structure and methodology aspects of the invention are essentially fully described to one of relevant skill in the art by the contents of the drawings.

### DESCRIPTIONS OF THE DRAWINGS

FIG. 1 is a high-level, block/schematic diagram employed herein in a dual-function manner to illustrate both a knowledge-domain-general, and a knowledge-domain-specific, embodiment of the case-entity system of the present invention.

FIG. 2 furnishes a pair of representative (but non-exhaustive) teaching illustrations of content revisions that may be made by system digital-engine structure in the organization and contents of Master Keys that form part of the medical-condition case entity pictured in FIGS. 2, 4 and 5.

FIG. 3 illustrates alignment registry mapping of a patient-specific case entity to either or both of two Master-Key case entities.

FIG. 4 illustrates alignment registry mapping of two between different patient-specific case entities to one another

FIG. 5 illustrates alignment registry mapping of two patient-specific case entities to a patient-global case entity.

FIG. 6 presents high-level, block/schematic diagram illustrating methodology proposed and offered by the present invention.

### DETAILED DESCRIPTION OF THE INVENTION

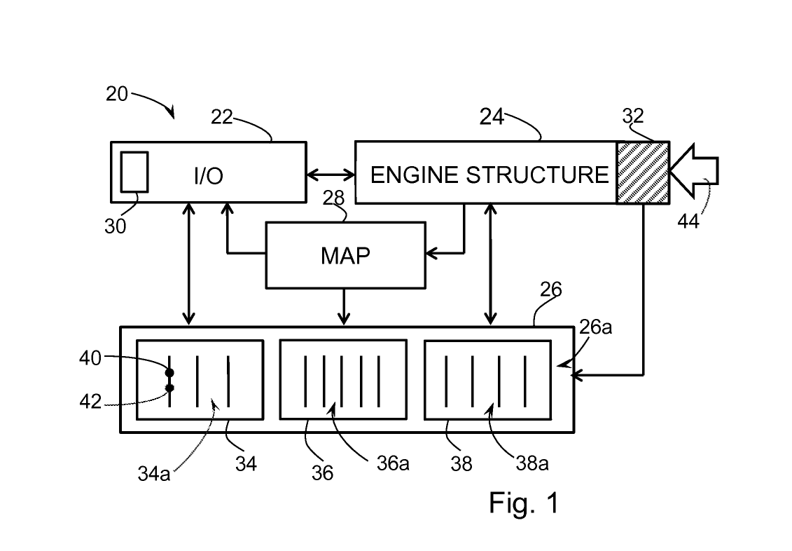

Turning attention now to the drawings, and referring first of all to FIG. 1 considered in its role of illustrating a knowledge-domain-general implementation of the invention, indicated generally at 20 is a computer-based, chronology-centric, knowledge-domain information handling system constructed in accordance with the present invention for use, when equipped with the appropriate, domain-specific data structure, in association with a very wide variety of selectable/definable knowledge domains. System 20 is employable specifically with regard to knowledge domains which are of a type that contains subject-matter entities, conditions or situations that consist of, or display, a chronological evolution or progression, respecting which data relevant, for examples, to a character-assessment, and/or a staging-status-appraisal, of such an entity, condition or situation varies over time, and can be modeled, in accordance with practice of the invention, for exploratory understanding, learning, and potentially predictive power employing use, of what we refer to, as mentioned above herein, as the chronology-centric, “case-entity” format feature of the invention.

System 20 accommodates the inputting, processing, and outputting, including visual, and even pictorially graphical, outputting, of domain-relevant data and associated information under the external control of a system user seeking selected knowledge-domain matter-assessment and other information, such as related, subject-matter-linked potential user-subject-matter-interaction guidance information for dealing, in one way or another, with the domain subject matter regarding which the user has engaged system 20.

In FIG. 1, four principal blocks, 22, 24, 26, 28, and certain included sub-blocks shortly to be mentioned more specifically, fully describe the organization of, and to some extent the present invention's operational methodology implemented by, system 20. These four blocks are operatively interconnected for system operation by appropriate, data-handling and information flow connections that are represented by appropriately arrow-headed, block-interconnecting lines (not specifically numbered herein).

Block 22, labeled “I/O”, is a system input/output, user-interactive, interface structure which includes visual display structure, represented by an internally drawn sub-block 30. Structure 22 accommodates the bidirectional flow, under user control and request, etc., of data and information relative to the intended performance activity of system 20.

Block 24, labeled “Engine Structure”, is a digital-computer-based data-processing engine structure which includes, represented in a shaded, internal, sub-block rectangle 32, what is referred to herein as case-entity-chronology revision structure. Engine structure 24, and its included case-entity-chronology revision structure, internally, and collaboratively, control and manage all data-handling functions, including all case-entity-associated dynamic changing and use-related operations, and further including all stored (and storing) EDP time-stamping and historical-content chronology organizing and managing tasks, in system 20. The engine structure is suitably algorithmically programmed to function in these manners through programming which is conventional in its basic nature, readily implementable in a variety of ways known to those skilled in the art with regard to computer programming, not part of the fundamental case-entity features of the present invention, and accordingly not described in any detail herein. A skilled programmer who reads the herein provided description of the invention, including the content of the '280 patent, along with the several herein included drawing figures, will be enabled easily to create relevant, functional programming for all system-20 operational requirements

Block 26 (not “word-labeled”) is an EDP data repository which, as shown in FIG. 1 for the general, unspecified knowledge-domain realization of the invention now being described, contains a digital electronic data structure 26a in the form of plural, dynamically revisable, EDP-containing case entities represented by sub-blocks 34, 36, 38. With system 20 configured to function with respect to a particular, selected knowledge domain, each case entity in repository 26, of which there will typically be many more than three, will be data-structured specifically to relate to some particular aspect of the selected knowledge domain. Such a case entity might be either an assessment-based case entity, or a Master-Key-based case entity.

Each of these case entities is constructed with plural, internally chronologically organized, EDP-data groups, with each such group containing EDPs that effectively define some particular, time-based stage or condition of the related case-entity subject matter. In a specifically defined knowledge domain, such as the knowledge domain of medicine, a repository collection of case entitles will typically include both (a) Master-Key case entities each possessing an included group of EDP-data Master Keys, and (b) assessment-based case entities (as above described) each possessing an included group of assessment-based EDP-data groups.

In FIG. 1, case entity 34 is a Master-Key case entity including three Master-Key EDP groups, or Master Keys, designated collectively 34a, and case entities 36, 38 are assessment-based case entities including, respectively, five assessment EDP groups, or assessments, designated collectively 36a, and four assessment EDP groups, or assessments, designated collectively 38a. The EDP groups in each of these case entities are appropriately time-and-stage-of-condition-stamped and organized, and each EDP group is schematically represented simply by a single, bold, dark vertical line. Time relative to these graphically illustrated case entities may be thought of visually as progressing from left to right.

Each of the Master-Keys in case entity 34 includes one or more EDP patterns that constitute Result Keys, and two such Result Keys are schematically represented in FIG. 1 by the two, large, darkened dots 40, 42 that are marked on the vertical line which represents the left-most Master Key pictured in this case entity.

Block 28, labeled “Map”, is what is referred to herein as case-entity-chronology mapping structure. It is this structure, under the direct control of engine structure 24, which implements the very powerful, information-conveyance, invention-enabled tool, based typically upon a user-request, for effecting time-based registry alignment(s) (referred to as mapping, to be more fully described and discussed later herein), between different (two or more, as desired) case entities selected from repository 26.

Visual display structure 30 in the interface structure functions to furnish visual, system-performance output information including readable text transformed from electronic data, and also, very significantly, what was mentioned above as “pictorially graphical” output information, especially as such pictorial information is associated with a data-transformed visual representation of the result of a case-entity mapping operation.

Case-entity-chronology revision structure 32 in engine structure 24 responds to case-entity-chronology revision information received, as represented by broad arrow 44 in FIG. 1, from different sources, for acting upon such received information to revise, within selected case-entity chronologies in the data repository, one or more selected, included EDP groups, in manners respecting, as appropriate, both (a) time-stage EDP-group organization within the chronology, and EDP content within a selected, included EDP group. Revision information sources are many, and include, as illustrations, (a) new information contained in relevant published literature, (b) new, relevant expert subject-matter conclusions made known, (c) data patterns found in ongoing system input information, (d) fresh information about the time-based experiential or natural history of case-entity subject matter, (e) relevant social media material, and (f) others.

The non-numbered arrow-headed lines drawn in FIG. 1 to show principal data-flow interconnections that exist between different blocks in this figure include, as can be seen, a direct connection between blocks 22, 24, direct connections between each of blocks 22, 24 and block 26, a direct connection between sub-block 32 in block 24 and block 26, and a pair of connections extending between block 28 and each of blocks 22, 24.

Considering now FIG. 1 in its “other” role herein of illustrating a knowledge-domain-specific embodiment of system 20, and in particular a medical knowledge-domain embodiment of the system employed with a focus on the disease category of medical condition, and specifically with a focus on a particular, selected disease, all that one needs to visualize to “see” this is that the nature of data 26a becomes specific, in the medical-knowledge domain, to the selected disease. The “basic”, chronologically organized, electronic, EDP-group-within-case-entity character of data structure 26a is the same as that described for the general-application situation just explained above.

In this realization of system 20, case-entity 34 is a medical-condition-specific Master-Key case entity possessing plural, chronologically organized, historical-content, time-stamped, stage-of-disease-condition-related EDP Master-Key groups, or Master Keys, 34a, each of which is linked specifically to the selected disease, with the left-most Master Key in this case entity shown, as earlier described, including one or more EDP patterns that constitute Result Keys 40, 42, that, in this illustration of system 20, point specifically to the selected disease.

Case entity 36 is a particular-chosen-patient, patient-specific, assessment-based case entity possessing plural, chronologically organized, historical-content, time-stamped, EDP assessment groups, or assessments, 36a, each of which describes the medical status of the chosen patient at different times associated with clinical encounters where the system has been called upon to produce a patient-status EDP assessment. In the present illustration, each assessment 36a includes EDPs that predominantly point toward the specific disease of interest, though they may also include other EDPs which either point yet to no other disease condition, or even to one or more different disease conditions.

Case-entity 38 is a patient-population-global, or patient-global, many-assessments-based case entity which is similar to case entity 36, and which possesses plural, chronologically organized, historical-content, time-stamped, EDP assessment groups, or assessments, 38a, each of which describes the medical status of a large population of patients at different times associated with clinical encounters where the system has been called upon to produce a patient-status EDP assessment. In the present illustration, and as with the situations involving just-described assessments 36a, each assessment 38a includes EDPs that predominantly point toward the specific disease of interest, though they may also include other EDPs which either point yet to no other disease condition, or even to one or more different disease conditions.

One should understand, of course, that many more of these three different types of case entities respecting the medical condition system illustration just described will typically be included in data structure 26a.

In relation to this “second-role” discussion involving system 20 as pictured in FIG. 1, case-entity-chronology revision structure 32 in engine structure 24 responds, as before described, to case-entity-chronology revision information received, as represented by broad arrow 44, from different sources, for acting upon such received information to revise, within selected case-entity chronologies in repository 26, one or more selected, included EDP groups, in manners, as pointed out above, respecting, as appropriate, both (a) time-stage EDP-group organization within the chronology, and EDP content within a selected, included EDP group. Revision information sources are many, and include, as illustrations, (a) new information contained in relevant published literature, (b) new, relevant expert subject-matter conclusions made known, (c) data patterns found in ongoing system input information, (d) fresh information about the time-based experiential or natural history of case-entity subject matter, (e) relevant social media material, and (f) others.

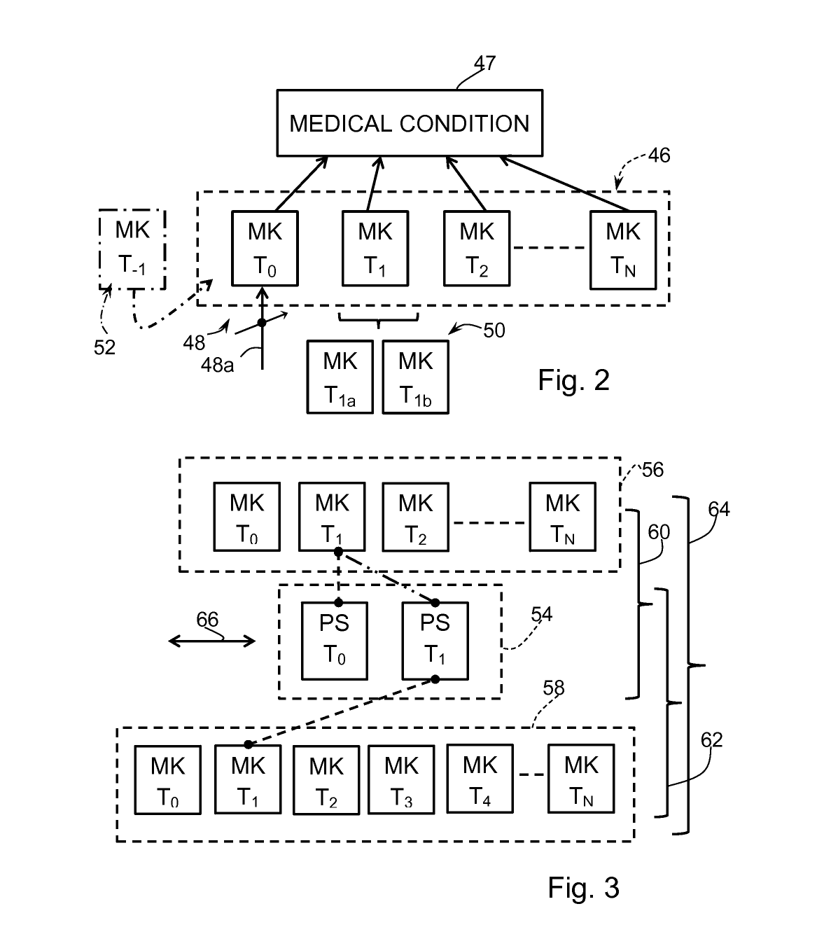

FIG. 2 illustrates three different kinds of revisions, of the many that are possible, which may take place within the EDP contents and organizations of EDP groups included within a case entity. More specifically, a dashed-line block 46 in this figure represents a medical-condition-specific case entity, wherein all of the included Master-Key EDB groups, or Master Keys, are effectively linked to a single medical condition which is represented in this figure by a block 47. Within case-entity block 46, there are shown in FIG. 2 four, different, chronologically organized Master Keys, respectively time-stamp, or stage-of-condition, labeled, in an appropriate time sequence, T0, T1, T2 and Tn.

In FIG. 2 there are illustrated, generally at the locations designated 48, 50, 52, three, specifically different illustrations of the collaborative operations of engine structure 24 and case-entity-chronology revision structure 32 to make revisions in the EDP content and organization of case entity 46. The specific revision which is illustrated at location 48, which revision is schematically represented by an adjustable arrow 48a, involves an EDP content revision within the Master Key identified with the time stamp T0. At revision location 50, an organizational revision is indicated involving, effectively, and because of some newly introduced medical-condition-related information, a splitting of the Master Key at T1 into two Master Keys, time-sequenced, and designated T1a and T1b. At revision location 52, which is illustrated in dash-dot lines, what is pictured is an organizational revision of case entity 46 to recognize that the medical-condition subject matter to which this case entity links has been found to possess an earlier stage, time-stamp-labeled T-1.

As mentioned above, many kinds of case entity revisions are possible. The three illustrations just presented are good representations of several key types which may be made.

As has been mentioned earlier, except with respect to the operational presence and utility of the unique, case-entity data structure proposed by the present invention, much of the assessment-based and reporting operations of system 20, in all realizations of that system, are essentially the same as, or very similar to, operations likewise performed in the system, and by the methodology, disclosed in the '280 patent. Accordingly, and with the exception now of a very brief, summarizing explanation, of system operation leading to the point of utilization of the case-entity data structure, we again direct one's attention to the full text and drawing disclosure content of the '280 patent for a detailed and elaborated discussion of operations which, while forming no part of the present invention, are useful to understand in the context of appreciating the value and power linked to the case-entity data-structure contributions made by the present invention.

When a user wishes to perform a medical-status assessment of a patient, typically conducted in a dialog manner during what is known as a clinical encounter, the user, based upon discussion with that patient, enters starting-point information, which may be very basic, simple, and fundamental information, regarding patient medical status, and following entry of this initial information, the knowledge system and methodology begin the task of arriving at a reportable medical condition assessment result effectively by comparing input information in its EDP form, with Master-Key information in the relevant database to determine whether any, at that point available, EDP input information strikes, or hits, a Result Key in a Master Key. The system and methodology, once such a hit occurs, may recurrently request and act upon refinement information based upon system-addressed refinement questions, all for the purpose of building a collection of EDP input information, recurrently reviewed in the realm of Master Keys, to locate additional, reportable result key hits, or to alter the certainty level associated with Master-Key EDP intersection with an assessment.

All of this activity takes place in a bi-directional, data-flow, dialog manner at the location of the user input/output interface in the system, where output information typically appears as electronically transformed (from data repository electronic data) text and/or graphical presentation material furnished via the visual display structure included in the interface structure.

Whereas all of this activity, in the system and methodology disclosed in the '280 patent, occurs in relation to what has been described above as a static data structure, and wherein each reportable result is specifically linked to one, and one only, Master Key, a greatly different behavior occurs respecting the case-entity, chronology-centric data structure of the present invention.

For example, during a patient's-medical-status assessment process, input data is compared with all of the relevant Master Keys that sit in all relevant, time-stamped, plural Master-Key EDP groups resident within case entities to locate, ultimately, a Result Key hit that takes place with respect typically to just one of those plural, case-entity Master Keys.

Time-successive, time-displaced clinical assessment encounters result in the creation of date-time-stamped and chronologically organized assessment data groups that become placed within, and part of, a patient-specific case entity, so that it becomes possible, over time, for a system and methodology user to see a rich, historical-content, chronological presentation that effectively characterizes and identifies a particular patient.

While patient-specific case entities are thus specifically date-time-stamped, Master-Key case entities, which, of course, are developed over time, somewhat differently relate, without specific reference to starting and ending times, to a historical presentation of the development and overall life, so-to-speak, of a knowledge domain subject matter, such as a medical condition.

In the use of the system and methodology of the present invention, therefore, a user is offered very powerful tools for gaining knowledge, and perhaps for guiding implementation management controls, of and over subject matter conditions, such as patient-diagnosed diseases. The user is specifically given the opportunity to implement important mapping functions between different case entities in the process of capturing and utilizing impressive, historical knowledge about the relevant domain-associated subject matter with respect to which a specific realization of the invention is focused.

FIGS. 3-5, inclusive, variously illustrate certain implementable mapping functions, specifically enabled by the case-entity data structure of the present invention.

FIG. 3 illustrates, in three, dashed-outline blocks 54, 56, 58, three different case entities, regarding which case entity 54 is a patient-specific (PS) case entity, and case entities 56, 58 are two, different Master-Key (MK) case entities.

Three brackets are presented adjacent the right side of FIG. 3, to indicate registry alignment mapping in different ways associated between these three case entities. A bracket 60 illustrates registry alignment mapping between case entities 54, 56. A bracket 62 illustrates registry alignment mapping between case entities 54, 58. Finally, a bracket 64 represents registry alignment mapping between all three case entities.

A horizontal, double-headed arrow 66 is included in FIG. 3 to represent, what may be thought of as relative time shifting between different case entities to achieve what has been referred to as registry alignment.

While specifically different, and user-selectable, registry alignment strategies may be employed, fundamentally, to achieve information-yielding alignment, what will usually be performed is an alignment that registers strongly similar EDP patterns found to exist commonly in pairs, or in larger groups, of mapped case entities.

In FIG. 3, and considering the mapping operation represented by bracket 60, there illustrated are two, different, potentially best-case, but independently so, registry alignments which are respectively illustrated by two, different, pairs of line-connected, enlarged, darkened dots that appear associated with different pairs of EDP groups in case entities 54, 56.

Bracket 62, which represents registry alignment between case entities 54, 58, illustrates a single potential registry condition, here also pictured by a pair of line-connected, enlarged, darkened dots.

The three-case-entity registry alignment operation represented by bracket 64 may be viewed as including some combination of the registry alignments just discussed specifically between the two different pairs of case entities.

Such alignment registry offers a user an extraordinary opportunity to learn, for example in a medical knowledge domain, how the apparent progress of a specific patient's medical status may be viewed, in terms of its chronology, with the condition-staged chronologies evident in medical-condition-specific, Master-Key case entities. Information respecting such mapping may be presented to a user through the visual display structure in the system interface in different appropriate ways, such as in text forms, and in pictorial graphic forms, where the latter forms might well look a bit like what is specifically shown for the three case entities relatively mapped as illustrated in FIG. 3.

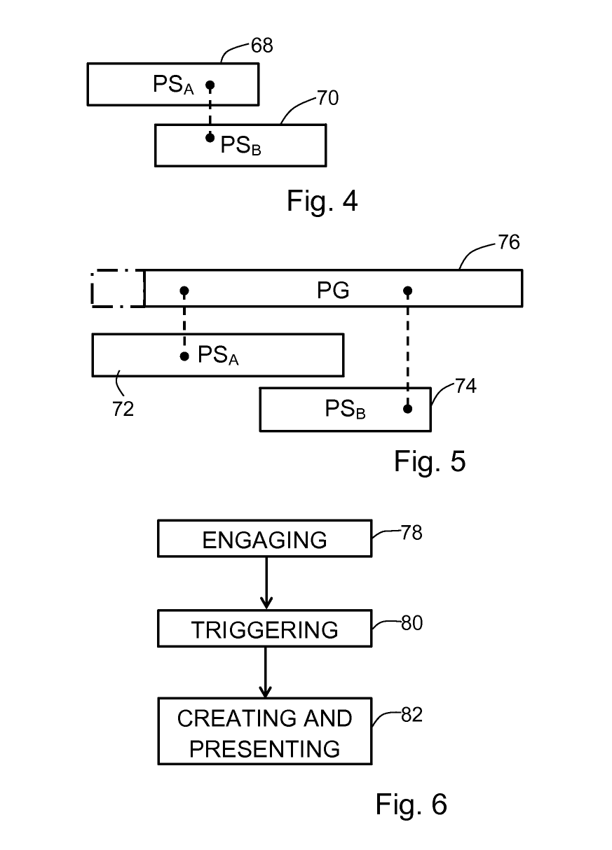

FIGS. 4 and 5, each present, in a graphical format which is somewhat simpler than that employed in FIG. 3, several other kinds of registry alignment mapping operations.

In FIG. 4, a mapping is illustrated between a pair, 68, 70, of different-patient, patient-specific (PS) case entities—a mapping which allows a user to draw informative knowledge from medical statuses associated, for example, with two different patients who may be experiencing a similar medical condition defined for these patients by similar case entities. One especially important consequence of such mapping is that it could warningly note the onset of a troublesome case-entity divergence signaling a need for special therapeutic intervention to prevent a serious medical/health consequence.

FIG. 5 illustrates registry alignment mapping performed between two, patient-specific (PS) case entities, 72, 74, and a particular, singular patient-population-global (PG) case entity 76. To be noted here with regard to the registry alignment mapping which is illustrated between case entities 72, 76, is that this particular mapping condition demonstrates a need to effect a revision in the case entity 76 regarding the needed introduction, into that case entity, of earlier-than-previously understood time-stamped information. This condition, relating to a need to revise case entity 76, is pictured in dash-dot lines.

The key methodology proposed by the invention is illustrated by appropriately word-labeled blocks 78, 80, 82 in FIG. 6. As mentioned earlier, this methodology may be expressed, in the specific realm of medicine, as a chronology-centric medical-condition assessment, diagnosis, and medical-condition management-guidance methodology including:

(A) engaging (Block 78), through an appropriate interface, and via EDP-associated dialogue relating to an inquiry respecting at least one of (1) presently assessed status, and (2) time-forward management-guidance, aspects of a patient's medical condition, a computer-based medical knowledge system which includes a data-processing engine, and an operatively connected, dynamically revisable data structure characterized by containing plural, medical-condition-related EDPs that represent, in digital electronic forms, physical aspects of human physiology and health, organized, in different parts of the repository, into (a) plural, medical-condition-specific, historical-content, time-and-stage-of-condition-organized, Master-Key case-entity chronologies, and (b) medical-condition-associated, historical-content, (i) patient-population-global, and (ii) individual patient-specific, assessment-based and internally time-organized, case-entity chronologies, wherein each case-entity chronology includes, as relevant to the subject-matter nature of EDPs in the chronology, groups of EDPs that effectively define, in relation to a given case entity, respectively different stage-and-time EDP-condition identities of the chronology-associated subject matter; and

(B) by such engaging, triggering (Block 80) to come as output from the system visually readable output information which identifiably characterizes the inquiry, in a time-based registry alignment manner, as possessing a present relationship of the patient's medical status to one or more medical-condition, historical-content chronologies.

As has also been mentioned, this methodology may also be structured whereby the triggering of visually readable output information implements the creating, and presenting (Block 82) on a visual display structure which is associated with the mentioned interface, of time-based graphical imagery picturing time-and-stage-of-condition EDP-content registry alignments between different case-entity chronologies present in the repository.

One should recall here that this medical-realm-specific expression of the invention methodology may also be read, through appropriate “other-realm” language substitution, on like methodology practicable in many other knowledge domains.

Reviewing what has thus been presented herein, it will be evident that the present invention makes a significant contribution to the field of knowledge-domain information handling. It recognizes the importance of bringing the substance, and the reality, of time-progressive, knowledge-domain subject-matter-variant history—a history providing a rich, data-supporting chronology—into the foreground of subject-matter condition and status exploration and understanding. By implementing this recognition, it introduces a powerful, modified and extended, form of what is illustrated and described in the predecessor '280 patent. There are many

Mentioning, again in certain instances, several useful advances offered by the present invention over the prior art, and outlining some of these advances representationally in the field of medicine:

1. In comparison with the basic operational behavior of the predecessor system and methodology set forth in the '280 patent, the proposed case-entity data structure reduces computational burden on the included engine structure during patient assessments;

2. Segmenting of the relevant EDPs associated with a medical condition into time-blocked sets in a medical-condition case entity allows the processing engine to process only those EDPs that are important to a particular phase, or stage, of the associated condition;

3. Potential data conflicts that could be introduced by EDPs relating to earlier stages of a condition being explored are eliminated;

4. Management of medical condition-specific case entities is simplified because the smaller time-blocked Master Keys (the relevant EDP groups) associated with differing time-blocks can be updated in isolation from the total set of EDPs associated with the condition;

5. Introducing the ability to register the best fit of a patient-specific case entity (medical record of an individual) with the various time-block Master Keys of a medical condition-specific case entity improves the degree of confidence that system “output recommendations” are correct;

6. Introducing the ability to register the best fit of a patient-specific case entity (medical record of an individual) with the various time-block Master Keys of a medical condition-specific case entity improves the specificity and timeliness of system management and therapeutic recommendations;

7. Introducing the ability to register the best fit of a patient-specific case entity (medical record of an individual) with the various time-block Master Keys of a group of medical condition-specific case entity improves the ability of the system to differentiate amongst a set of competing conditions;

8. Predictive analysis

9. Introducing the ability to register the best fit of a patient-specific case entity (medical record of an individual) with the various time-block Master Keys of a medical condition-specific case entity allows a clinician effectively to predict important patient evolutions, clinical milestones, or effective surveillance strategies by analyzing the content of time-block Master Key elements that are beyond the current intersection;

10. Introducing the ability to register the best fit of patient-global case entities (aggregated medical records) with a patient-specific case entity (medical record of an individual) allows a clinician to determine future outcomes for a patient based upon historical patterns of behavior and case evolution gleaned from global case entities.

The system and methodology of the invention are applicable to any knowledge domain of a type which contains subject-matter entities, conditions or situations that consist of, or display, a chronological evolution or progression, respecting which data relevant to a character-assessment, and/or a staging-status-appraisal, of such an entity, condition or situation varies over time, and can be modeled using the chronology-centric, “case-entity” format of the present invention.

While we have disclosed and described the invention both generally, and in relation to one specific area of practice, we are very aware of, and have in several ways mentioned above, its utility in widely diverse knowledge domains.

We claim:

1. In a chronology-centric, defined-knowledge-domain information-handling system which accommodates the inputting, processing, and outputting, including visual outputting, of domain-relevant data and associated information under the external control of a system user seeking selected knowledge-domain matter-assessment and other information, such as related, subject-matter-linked, potential user-subject-matter-interaction guidance information,
a dynamic EDP data repository,
plural EDP case-entity chronologies stored as EDP data in said repository in the forms of respective, internally time-stamped and chronologically-organized groups of EDPs that effectively define, in relation to a given case entity, respectively different stage-and-time EDP-condition identities of particular domain-associated subject matter, and
data-processing engine structure operatively connected to said repository, operable, in accordance with user information-flow interactions with the system, and utilizing appropriately the data inputting, processing and outputting capabilities of the system, for recurrently and progressively interacting with the data repository in relation to at least one of constructing, re-constructing, accessing, and reporting the respective organizations, contents and significances of, selected case-entity chronologies, as well, if user requested at a particular point in time, as performing, and output reporting user-sought information associated with, relevant, selected, time-and-stage EDP-content registry alignments between different case-entity chronologies present in the repository.

2. The system of claim 1, wherein the defined knowledge domain is the domain of medicine, and the domain-related subject matter involves patients and patient medical conditions.

3. The system of claim 2, with respect to which a medical condition takes the form of one of a disease, a disease diagnosis, a medical procedure, and a therapeutic protocol.

4. The system of claim 2, wherein the repository-stored case-entity chronologies include patient-specific, patient-global, and medical-condition-specific chronologies, and the groups of EDPs that form the patient-specific and patient-global chronologies are groups of time-stamped, patient-condition-assessment EDPs, and the groups of EDPs that form the medical-condition-specific chronologies are groups of time-and-stage-of-relevance-stamped EDP Master Keys, wherein each Master Key in a particular medical-condition-specific chronology includes different subgroup patterns of EDPs that function as Result Keys, each of which points specifically to the chronology-related medical-condition.

5. The system of claim 2 which further includes visual display structure operatively connected to said engine structure, and wherein output reporting of user-sought information associated with relevant, selected, time-and-stage EDP-content registry alignments between different case-entity chronologies present in the repository takes the form of time-based graphical imagery picturing of such alignments.

6. A digital-computer-based, chronology-centric medical system for recurrently, and selectively, assessing a topically-chosen, patient-specific medical condition, and for thereby potentially enhancing, as appropriate, the management, over time, of any such condition, said system comprising
input/output interface structure, including visual display structure, (a) for time-noted inputting of patient-associated data relevant to performance by the system of a time-stamped, patient medical-condition assessment, and (b) for presenting, via said visual display structure, system-created EDP-based output information including (1) patient-associated, time-stamped, medical-condition assessment information, and (2) patient-medical-condition management-relevant guidance information,
appropriately programmed, data-processing engine structure operatively connected to said interface structure, operable for processing and handling input and output information relating to (1) assessments, and (2) medical-condition management-guidance information, associated with a patient,
a dynamic EDP data repository operatively connected to said interface structure and engine structures, containing plural, medical-condition-related EDPs organized, in different parts of the repository, and as appropriate for specific, different EDP-focus natures, into (a) plural, medical-condition-specific, historical-content, time-and-stage-of-condition-organized, Master-Key case-entity chronologies, and (b) medical-condition-associated, historical-content, (1) patient-population-global, and (2) individual patient-specific, assessment-based and internally time-organized, case-entity chronologies, wherein each case-entity chronology includes, as relevant to the subject-matter nature of EDPs in the chronology, groups of EDPs that effectively define, in relation to a given case entity, respectively different stage-and-time EDP-condition identities of the chronology-associated subject matter, and
case-entity-chronology revision structure, operable, as an included part of said engine structure, for receiving case-entity-chronology revision information, and for acting upon such received information to revise, within selected case-entity chronologies, one or more selected, included EDP groups, in manners respecting, as appropriate, both (a) time-stage EDP-group organization within the chronology, and (b) EDP content within a selected, included EDP group.

7. The system of claim 6, wherein the groups of EDPs that form the patient-specific and patient-global chronologies are groups of time-stamped, patient-condition-assessment EDPs, and the groups of EDPs that form the medical-condition-specific chronologies are groups of time-and-stage-of-relevance-stamped EDP Master Keys, wherein each Master Key in a particular medical-condition-specific chronology includes different subgroup patterns of EDPs that function as Result Keys, each of which points specifically to the chronology-related medical-condition.

8. The system of claim 6 which further comprises case-entity-chronology mapping structure operatively interposed said engine and interface structures, operable, under the control of the engine structure, to map to one another, on the basis, as appropriate, of time-stage, and/or date-stamped-assessment, registry alignment of related, contained, EDP group information, different case-entity chronologies present in said repository.

9. The system of claim 8, wherein said mapping structure is configured, relative to said visual display structure, to present, for viewing transformably on the latter, information regarding case-entity-chronology mapping for uses at least in the realms of (a) case-entity comparisons and understandings, and (b) medical-conditions management.

10. The system of claim 6, with respect to which a medical condition takes the form of one of a disease, a disease diagnosis, a medical procedure, and a therapeutic protocol.

11. In a digital-computer-based medical system for recurrently, and selectively, time-stamp assessing and diagnosing a patient's disease-related medical condition, and for thereby enhancing the management over time of any such diagnosed patient medical condition, wherein the system includes input/output interface structure for the bidirectional flow of information relative to performance activity in the system, and data-processing engine structure operatively connected to the interface structure for processing and handling input and output information, the combination comprising
a dynamic EDP data repository operatively connected to the interface and engine structures, containing digital electronic data structure having a dynamically addressable and selectively revisable organization and content which are central to system performance, said data structure including plural, medical-condition-related EDPs that represent, in digital electronic forms, physical aspects of human physiology and health, organized, in different parts of the repository, and as appropriate for specific, different EDP-focus natures, into (a) plural, medical-condition-specific, historical-content, time-and-stage-of-condition-organized, Master-Key case-entity chronologies, and (b) medical-condition-associated, historical-content, (1) patient-population-global, and (2) individual patient-specific, assessment-based and internally time-organized, case-entity chronologies, wherein each case-entity chronology includes, as relevant to the subject-matter nature of EDPs in the chronology, groups of EDPs that effectively define, in relation to a given case entity, respectively different stage-and-time EDP-condition identities of the chronology-associated subject matter, and
case-entity-chronology revision structure, operable, as an included part of said engine structure, for receiving case-entity-chronology revision information, and for acting upon such received information to revise, within selected case-entity chronologies, one or more selected, included EDP groups, in manners respecting, as appropriate, both (a) time-stage EDP-group organization within the chronology, and (b) EDP content within a selected, included EDP group.

12. The system of claim 11, wherein the groups of EDPs that form the patient-specific and patient-global chronologies are groups of time-stamped, patient-condition-assessment EDPs, and the groups of EDPs that form the medical-condition-specific chronologies are groups of time-and-stage-of-relevance-stamped EDP Master Keys, wherein each Master Key in a particular medical-condition-specific chronology includes different subgroup patterns of EDPs that function as Result Keys, each of which points specifically to the chronology-related medical-condition.

13. The system of claim 11 which further comprises case-entity-chronology mapping structure operatively interposed said engine and interface structures, operable, under the control of the engine structure, to map to one another, on the basis, as appropriate, of time-stage, and/or date-stamped-assessment, registry alignment of related, contained, EDP group information, different case-entity chronologies present in said repository.

14. A chronology-centric medical-condition assessment, diagnosis, and medical-condition management-guidance methodology comprising
engaging, through an appropriate interface, and via EDP-associated dialogue relating to an inquiry respecting at least one of (a) presently assessed status, and (b) time-forward management-guidance, aspects of a patient's medical condition, a computer-based medical knowledge system which includes a data-processing engine, and an operatively connected, dynamically revisable data structure characterized by containing plural, medical-condition-related EDPs that represent, in digital electronic forms, physical aspects of human physiology and health, organized, in different parts of the repository, into (a) plural, medical-condition-specific, historical-content, time-and-stage-of-condition-organized, Master-Key case-entity chronologies, and (b) medical-condition-associated, historical-content, (1) patient-population-global, and (2) individual patient-specific, assessment-based and internally time-organized, case-entity chronologies, wherein each case-entity chronology includes, as relevant to the subject-matter nature of EDPs in the chronology, groups of EDPs that effectively define, in relation to a given case entity, respectively different stage-and-time EDP-condition identities of the chronology-associated subject matter, and
by said engaging, triggering to come as output from the system visually readable output information which identifiably characterizes the inquiry, in a time-based registry alignment manner, as possessing a present relationship of the patient's medical status to one or more medical-condition, historical-content chronologies.

15. The method of claim 14, wherein said triggering of visually readable output information implements the creating, and presenting on a visual display structure which is associated with the mentioned interface, of time-based graphical imagery picturing time-and-stage-of-condition EDP-content registry alignments between different case-entity chronologies present in the repository.
